(19) United States
(12) Patent Application Publication
(10) Pub. No.: US 2024/0426550 A1
(43) Pub. Date: Dec. 26, 2024

(54) DRYING PILL FOR PIPELINE OPERATIONS

(71) Applicant: Halliburton Energy Services, Inc., Houston, TX (US)

(72) Inventor: Philippe QUERO, Houston, TX (US)

(73) Assignee: Halliburton Energy Services, Inc., Houston, TX (US)

(21) Appl. No.: 18/213,154

(22) Filed: Jun. 22, 2023

(51) Int. Cl. F26B 5/16

(52) U.S. Cl. CPC F26B 5/16; E21B 37/06

(57) ABSTRACT

Drying pills for removing residual water from pipelines. An example method for drying a pipeline includes preparing a drying pill which includes a non-aqueous base fluid and a drying agent. The total volume of the drying pill is 500 bbl or less. The drying pill is introduced into the pipeline where the drying agent contacts residual water and is hydrated. The hydrated drying agent is then removed from the pipeline.

### TECHNICAL FIELD

The present disclosure relates generally to pipeline operations, and more particularly, to the use of a drying pill to improve water removal from pipelines.

### BACKGROUND

Pipelines may be subjected to hydrotesting, maintenance operations, inspections, cleaning operations, and the like. These operations may introduce aqueous fluids into the pipeline. Water left behind in the pipeline from these operations may corrode equipment or contaminate subsequently introduced pipeline fluids.

Traditional means for removing residual water from a pipeline may include drying equipment and air spreads. These methods can utilize great numbers of heavy equipment such as air compressors, vacuums, and dryers. The use of this equipment may increase the operational cost to perform pipeline operations. The removal of residual water is an important part of many pipeline operations. The present invention provides improved formulations and methods for removing residual water from a pipeline.

### BRIEF DESCRIPTION OF THE DRAWINGS

Illustrative examples of the present disclosure are described in detail below with reference to the attached drawing figures, which are incorporated by reference herein, and wherein:

FIG. 1 is an illustrative schematic of a system that can deliver examples of the drying pill to a pipeline in accordance with one or more examples described herein;

FIG. 2 is an illustrative schematic of a system for introducing the drying pill into a pipeline to remove residual water in the pipeline in accordance with one or more examples described herein;

FIG. 3 is a cross-section illustrating the interior of a pipeline treated with a drying pill in accordance with one or more examples described herein;

FIG. 4 is a photograph of the initial setup of an experiment to make a visual determination of the water absorption of a drying pill in accordance with one or more examples described herein;

FIG. 5 is a photograph of an experiment to make a visual determination of the water absorption of a drying pill after 45 seconds in accordance with one or more examples described herein;

FIG. 6 is a photograph of an experiment to make a visual determination of the water absorption of a drying pill after 5 minutes in accordance with one or more examples described herein;

FIG. 7 is a photograph of an experiment to make a visual determination of the water absorption of a drying pill after 12 minutes in accordance with one or more examples described herein;

FIG. 8 is a photograph of an experiment to make a visual determination of the water absorption of a drying pill after 30 minutes in accordance with one or more examples described herein; and

FIG. 9 is a photograph of an experiment to make a visual determination of the water absorption of a drying pill after 1 hour in accordance with one or more examples described herein.

The illustrated figures are only exemplary and are not intended to assert or imply any limitation with regard to the environment, architecture, design, or process in which different examples may be implemented.

### DETAILED DESCRIPTION

The present disclosure relates generally to pipeline operations, and more particularly, to the use of a drying pill to improve water removal from pipelines.

In the following detailed description of several illustrative examples, reference is made to the accompanying drawings that form a part hereof, and in which is shown by way of illustration specific examples that may be practiced. These examples are described in sufficient detail to enable those skilled in the art to practice them, and it is to be understood that other examples may be utilized, and that logical structural, mechanical, electrical, and chemical changes may be made without departing from the spirit or scope of the disclosed examples. To avoid detail not necessary to enable those skilled in the art to practice the examples described herein, the description may omit certain information known to those skilled in the art. The following detailed description is, therefore, not to be taken in a limiting sense, and the scope of the illustrative examples are defined only by the appended claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

In the following discussion and in the claims, the terms “including” and “comprising” are used in an open-ended fashion, and thus should be interpreted to mean “including, but not limited to.” Unless otherwise indicated, as used throughout this document, “or” does not require mutual exclusivity.

As used herein, a “pill” and any of its variations, refers to a small volume of fluid that is less than or equal to 500 barrels (“bbl”) of fluid. The pill is introduced into a pipeline to dry the pipeline by removing any residual water within the pipeline. Pipelines may contain residual water after certain operations are performed such as hydrotesting, maintenance operations, cleaning operations, inspection operations, and the like. The residual water may remain fixed to the interior surface of the pipeline and may be difficult to remove even after the use of drying equipment and air spreads. Should the water be allowed to remain in the pipeline, it may induce corrosion of the pipeline or contaminate fluids subsequently introduced into the pipeline such as hydrocarbon fluids. As an example, in CO₂ transportation applications, the presence of residual water may produce an acid that is extremely corrosive and damaging for the pipeline. Advantageously, a drying pill may be introduced to absorb the residual water on the interior surface of the pipeline, thereby easing its removal from the pipeline. The drying pill utilizes a drying agent carried in a base fluid. This drying agent may contact the water, absorb it, and remove it from the interior surface of the pipeline by flushing the hydrated drying agent from the pipeline. As an additional advantage, the drying pill may reduce or altogether replace the use of heavy equipment such as air compressors, vacuums, and dryers. A reduction in the use of air compressors and dryers may result in a reduction in expenditures and also reduce pipeline downtime.

The examples described herein utilize a drying pill for removing water from a pipeline. The drying pill comprises a base fluid of a total fluid volume between about 1 to about 500 barrels of fluid. The drying pill additionally comprises a drying agent capable of removing water from an interior surface of the pipeline. The drying agent contacts the residual water and is hydrated. The hydrated drying agent may then be carried by the base fluid to the exit of the pipeline to be removed from the pipeline. In some optional examples, the drying pill may comprise additional components other than the base fluid and the drying agent. These additional components of the drying pill may alter a property of the drying pill such as its density or viscosity. The components of the drying pill may be provided and mixed in any order.

The drying pill comprises a non-aqueous base fluid. The base fluid may be any non-aqueous fluid sufficient for transporting the drying agent in the pipeline. Additionally, the base fluid should be capable of transporting the drying agent once the drying agent has contacted any residual water, so as to remove both the drying agent and the residual water from the pipeline. In some optional examples, the base fluid possesses a boiling point low enough that it can be easily evaporated from within the pipeline, if desired, so as to remove any residual base fluid from the pipeline. Examples of the base fluid include, but are not limited to, methanol, monoethylene glycol, triethylene glycol, isopropyl alcohol, or any combination of base fluids.

The concentration of the base fluid in the treatment fluid may range from about 50% (w/v) to about 99% (w/v). The concentration of the base fluid in the treatment fluid may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the base fluid in the treatment fluid may range from about 50% (w/v) to about 99% (w/v), from about 55% (w/v) to about 99% (w/v), from about 60% (w/v) to about 99% (w/v), from about 65% (w/v) to about 99% (w/v), from about 70% (w/v) to about 99% (w/v), from about 75% (w/v) to about 99% (w/v), from about 80% (w/v) to about 99% (w/v), from about 85% (w/v) to about 99% (w/v), from about 90% (w/v) to about 99% (w/v), or from about 95% (w/v) to about 99% (w/v). As another example, the concentration of the base fluid in the treatment fluid may range from about 50% (w/v) to about 99% (w/v), from about 50% (w/v) to about 95% (w/v), from about 50% (w/v) to about 90% (w/v), from about 50% (w/v) to about 85% (w/v), from about 50% (w/v) to about 80% (w/v), from about 50% (w/v) to about 75% (w/v), from about 50% (w/v) to about 70% (w/v), from about 50% (w/v) to about 65% (w/v), from about 50% (w/v) to about 60% (w/v)), or from about 50% (w/v) to about 55% (w/v). With the benefit of this disclosure, one of ordinary skill in the art will be able to prepare a treatment fluid having a sufficient concentration of an aqueous base fluid for a given application.

The drying pill comprises a drying agent to remove the residual water found on the surface of the interior of the pipeline. When the drying agent contacts the residual water, the drying agent is hydrated and the hydrated drying agent may be carried out of the pipeline by the base fluid. The mechanism of hydration may differ for each drying agent. Some preferred examples of the drying agents are swellable crosslinked polymers. The swellable crosslinked polymers absorb and store many times their own weight of aqueous liquids by forming a gel. Some examples of the swellable crosslinked polymers retain the liquid that they absorb and typically do not release the liquid, even under pressure. General examples of the swellable crosslinked polymers may include sodium acrylate-based polymers having three dimensional, network-like molecular structures. The polymer chains may be formed by the reaction/joining of millions of identical units of acrylic acid monomer, which have been substantially neutralized with sodium hydroxide (caustic soda). Crosslinking chemicals tie the chains together to form a three-dimensional network, enabling the swellable crosslinked polymers to absorb water or water-based solutions into the spaces within the molecular network. A gel may be formed with the residual water held within. Some additional examples of suitable swellable crosslinked polymers include, but are not limited to, crosslinked polyacrylamide; crosslinked polyacrylate; crosslinked hydrolyzed polyacrylonitrile; salts of carboxyalkyl starch, for example, salts of carboxymethyl starch; salts of carboxyalkyl cellulose, for example, salts of carboxymethyl cellulose; salts of any crosslinked carboxyalkyl polysaccharide; crosslinked copolymers of acrylamide and acrylate monomers; starch grafted with acrylonitrile and acrylate monomers; crosslinked polymers of two or more of allylsulfonate, 2-acrylamido-2-methyl-1-propanesulfonic acid, 3-allyloxy-2-hydroxy-1-propane-sulfonic acid, acrylamide, and acrylic acid monomers; or combinations thereof.

In some examples, the swellable crosslinked polymer is provided as a dehydrated, crystalline (i.e., solid) crosslinked polymer. One example of a crystalline swellable crosslinked polymer is polyacrylamide. Preferred examples of the swellable crosslinked polymer include those that have very low solubility in water or may be insoluble or practically insoluble in water. Additionally, swellable crosslinked polymers that can withstand temperatures up to at least 100° F. without experiencing breakdown may also be important. Other examples of crystalline swellable crosslinked polymers are starches having backbones grafted with acrylonitrile and/or acrylate. These crystalline swellable crosslinkable polymers deflect and surround water molecules during water absorption. In effect, the polymer undergoes a change from that of a dehydrated crystal to that of a hydrated gel as it absorbs water. Once fully hydrated, the gel usually exhibits a high resistance to the migration of water due to its polymer chain entanglement and its relatively high viscosity.

Other examples of swellable crosslinkable polymers may include crosslinkable biopolymers, including synthetic biopolymers and polymers derived from biopolymers. Examples of swellable crosslinkable biopolymers include, but are not limited to, starches (including amylose and/or amylopectin), chitosans, hemicelluloses, lignins, celluloses, chitins, alginates, dextrans, pullulanes, polyhydroxyalkanoates, fibrins, cyclodextrins, proteins (e.g., soy protein), polysaccharides (e.g., pectin), and/or polylactic acids.

In some examples, the crosslinkable polymers may be provided in a form that is water soluble. In those instances, the crosslinkable polymers may be further crosslinked until their water solubility is low enough so as to not impact their functionality in the present invention. Other examples of the drying agent are non-water soluble desiccants including, but not limited to, highly porous materials such as activated alumina, molecular sieves, silica gel, zeolites, or combinations of drying agents. These highly porous materials have very high surface areas due to their porous nature. These drying agents function as desiccants by drawing water within their porous surface and holding it within due to their porous structure or the surface charge of their respective materials. Once hydrated with the residual water, these drying agents may be removed from the pipeline.

Additional examples of drying agents include those materials that swell upon contact with water. These swellable drying agents have very low solubility in water or are insoluble in water. Examples of the swellable drying agents include clays, rice, or any combination of materials. Specific examples of swellable clays include those of the smectite group, including but not limited to, bentonite, hectorite, montmorillonite, nontronite, saponite, or any combination of materials. These drying agents swell upon contact with the residual water and hold the water within the structure. Once hydrated with the residual water, these drying agents may be removed from the pipeline.

The concentration of the drying agent in the drying pill may range from about 1% to about 60% wt. %. The concentration may range from any lower limit to any upper limit and encompass any subset between the upper and lower limits. Some of the lower limits listed may be greater than some of the listed upper limits. One skilled in the art will recognize that the selected subset may require the selection of an upper limit in excess of the selected lower limit. Therefore, it is to be understood that every range of values is encompassed within the broader range of values. For example, the concentration of the drying agent in the drying pill may range from about 1% to about 60% wt. %, from about 5% to about 60% wt. %, from about 10% to about 60% wt. %, from about 15% to about 60% wt. %, from about 20% to about 60% wt. %, from about 25% to about 60% wt. %, from about 30% to about 60% wt. %, from about 35% to about 60% wt. %, from about 40% to about 60% wt. %, from about 45% to about 60% wt. %, from about 50% to about 60% wt. %, or from about 55% to about 60% wt. %. As another example, the concentration of the drying agent in the drying pill may range from about 1% to about 60% wt. %, from about 1% to about 55% wt. %, from about 1% to about 50% wt. %, from about 1% to about 45% wt. %, from about 1% to about 40% wt. %, from about 1% to about 35% wt. %, from about 1% to about 30% wt. %, from about 1% to about 25% wt. %, from about 1% to about 20% wt. %, from about 1% to about 15% wt. %, from about 1% to about 10% wt. %, or from about 1% to about 5% wt. %. With the benefit of this disclosure, one of ordinary skill in the art will be readily able to prepare and select a drying agent having a desirable concentration for the drying pill for a given application.

In some optional examples, the drying pill may comprise additional components. These optional components may be used to alter a fluid property of the drying pill, for example, the density, pH, or viscosity of the drying pill. Examples of these optional components may include, but are not limited to, weighting agents, crosslinkers, viscosifiers, weighting agents, solubilizers, salts, pH control additives, anti-oxidants, polymer degradation prevention additives, surfactants, bactericides, stabilizers, chelants, scale inhibitors, corrosion inhibitors, hydrate inhibitors, fibers, nanoparticles, gas, catalysts, dispersants, flocculants, scavengers (e.g., H₂S scavengers, CO₂ scavengers or O₂ scavengers), combinations thereof, or the like. With the benefit of this disclosure, one of ordinary skill in the art and the benefit of this disclosure will be able to formulate a drying pill having properties suitable for a desired application.

The drying pill has a viscosity that allows for pumping within the pipeline. The drying pill may be used in a variety of pipeline temperatures. For example, the drying pill may be used in pipelines having temperatures in a range of about 25° F. to about 100° F. The drying pill has a density suitable for pipeline drying applications. By way of example, the drying fluid may have a density in a range of from about 1 pound per gallon (“lb/gal”) to about 12 lb/gal. For densities of 7 lb/gal or lower, a gas such as air or nitrogen may be entrained in the drying pill to foam the foam the drying pill. In foamed examples, the foam quality may range from about 1% to about 80%, where the foam quality is the volume of entrained gas and is determined from the following formula: Foam Quality=(Total Foam Volume−Liquid Volume)/Total Foam Volume.

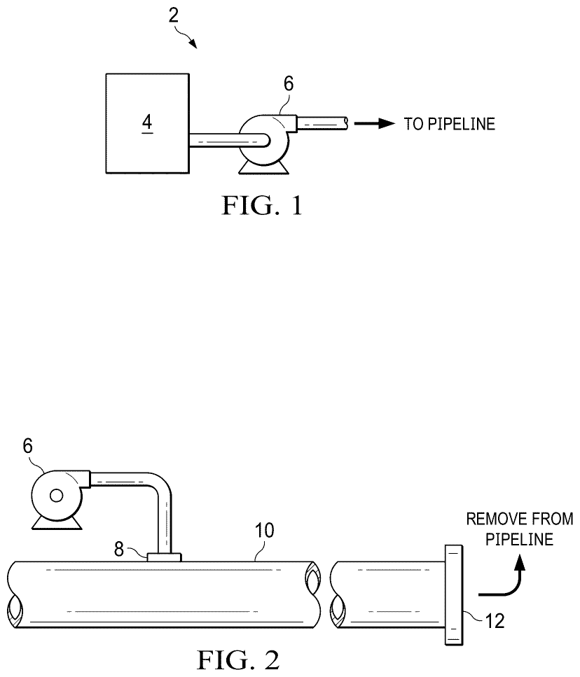

FIG. 1 shows an illustrative schematic of a system 2 that can deliver examples of the drying pill to a desired pipeline. It should be noted that while FIG. 1 generally depicts a land-based system, it is to be recognized that like systems can be operated in subsea locations as well. As depicted in FIG. 1, a system 2 comprises mixing equipment 4, in which the drying pill that is described herein may be formulated. As shown, the system 2 may be used to prepare the drying pill by mixing a base fluid, a drying agent, and any optional components in the mixing equipment 4. Examples of the mixing equipment 4 include, but are not limited to, a jet mixer, re-circulating mixer, or a batch mixer. The drying pill may then be pumped via pumping equipment 6 to the pipeline. In some examples, the mixing equipment 4 and the pumping equipment 6 may be disposed on one or more mixing trucks as will be apparent to those of ordinary skill in the art. In some examples, a jet mixer or other suitable mixer, may be used to continuously mix the base fluid and drying agent as they are being pumped into the pipeline. This continuous mixing at the point of or near the point of insertion may be referred to as on-the-fly mixing. Alternatively, the base fluid and drying agent maybe mixed together for a desired amount of time prior to insertion into the pipeline. The prepared drying pill may then be stored for a desired amount of time and introduced into the pipeline when ready for the drying operation.

It should be clearly understood that the example system illustrated by FIG. 1 is merely a general application of the principles of this disclosure in practice, and a wide variety of other examples are possible. Therefore, the scope of this disclosure is not limited in any manner to the details of FIG. 1 as described herein.

FIG. 2 is an illustrative schematic of a pipeline 10 containing residual water. Pumping equipment 6 is fluidically connected in line with the pipeline 10 and may be used to introduce the drying pill into the pipeline 10 via a port 8 or any other sufficient opening suitable for the introduction of the drying pill. When introduced into the pipeline 10, the drying pill is conveyed through the pipeline 10 via turbulent flow as opposed to laminar flow. The pumping equipment 6 may be used to provide turbulent flow to the drying pill. In some examples, additional equipment may be used to provide turbulent flow to the drying pill. The turbulent flow may improve the ability of the drying agent to contact the residual water disposed on the interior surface of the pipeline 10. When the drying agent contacts the residual water, the residual water may hydrate the drying agent thereby removing the residual water from the interior surface of the pipeline 10. The hydrated drying agent may then be carried by the base fluid of the drying pill to the exit 12 of the pipeline 10 where the hydrated drying agent may be removed. The removal of the hydrated drying agent from the pipeline 10 also results in the removal of the residual water that hydrated the drying agent.

It should be clearly understood that the example system illustrated by FIG. 2 is merely a general application of the principles of this disclosure in practice, and a wide variety of other examples are possible. Therefore, the scope of this disclosure is not limited in any manner to the details of FIG. 2 as described herein.

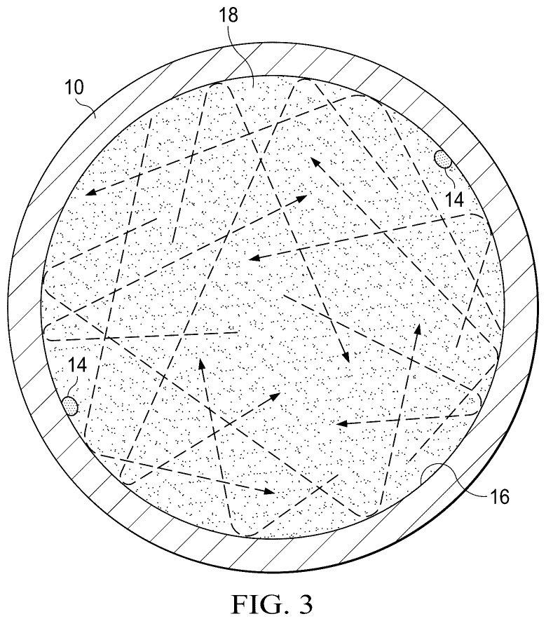

FIG. 3 is an illustrative cross-section of the pipeline 10 of FIG. 2. Within the pipeline 10, residual water 14 is disposed upon the interior surface 16 of the pipeline 10. The drying pill 18 has been introduced into the pipeline 10 and is turbulently flowing through the interior of the pipeline 10. The drying agent within the drying pill 18 may contact the residual water 14 and by hydrated by the residual water 14. Hydration of the drying agent with the residual water 14 may remove the residual water 14 from the interior surface of the pipeline 10. The hydrated drying agent may then be carried to the exit (i.e., exit 12 in FIG. 2) to be removed from the pipeline 10. In some examples, the drying pill 18 may be used to remove the residual water 14 from the pipeline 10 without the use of heavy equipment such as air dryers, vacuums, or air compressors. In some examples, the drying pill 18 may be used to remove the residual water 14 from the pipeline 10 without the use of air spreads such as nitrogen air spreads. In some examples, the drying pill 18 may be used to remove the residual water 14 from the pipeline 10 without the use of heavy equipment such as air dryers, vacuums, or air compressors as well as without the use of air spreads such as nitrogen air spreads.

It should be clearly understood that the example system illustrated by FIG. 3 is merely a general application of the principles of this disclosure in practice, and a wide variety of other examples are possible. Therefore, the scope of this disclosure is not limited in any manner to the details of FIG. 3 as described herein.

To facilitate a better understanding of the present embodiments, the following examples of certain aspects of some embodiments are given. In no way should the following examples be read to limit, or define, the entire scope of the embodiments.

### EXAMPLES

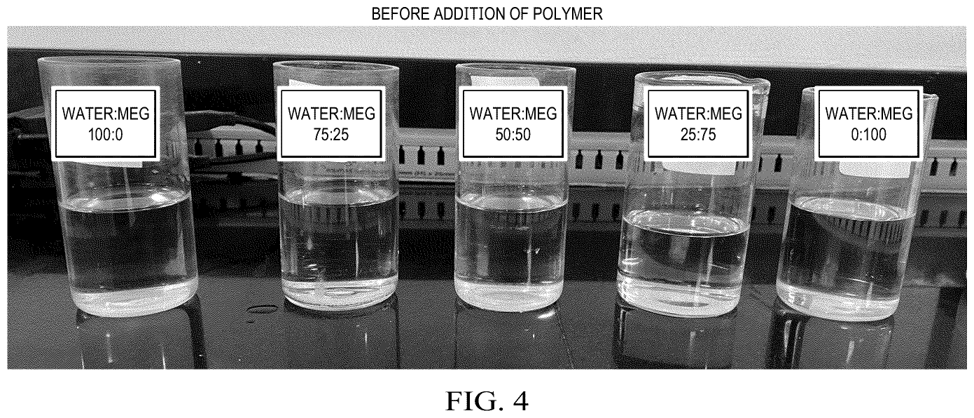

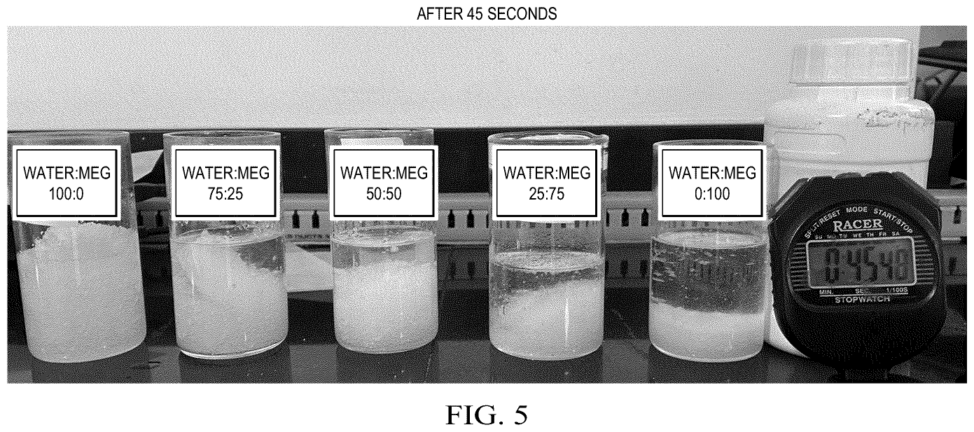

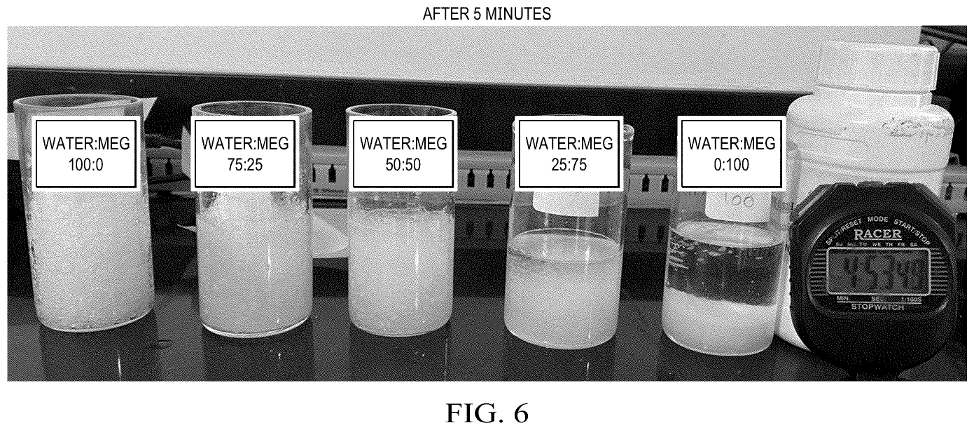

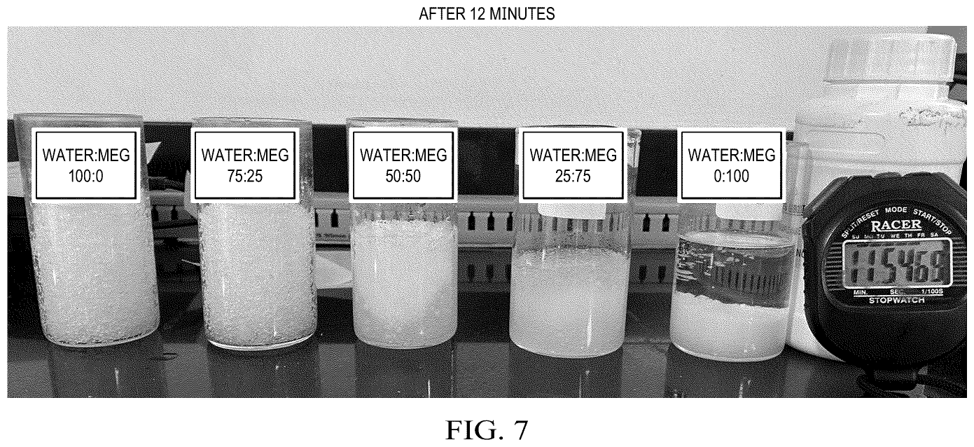

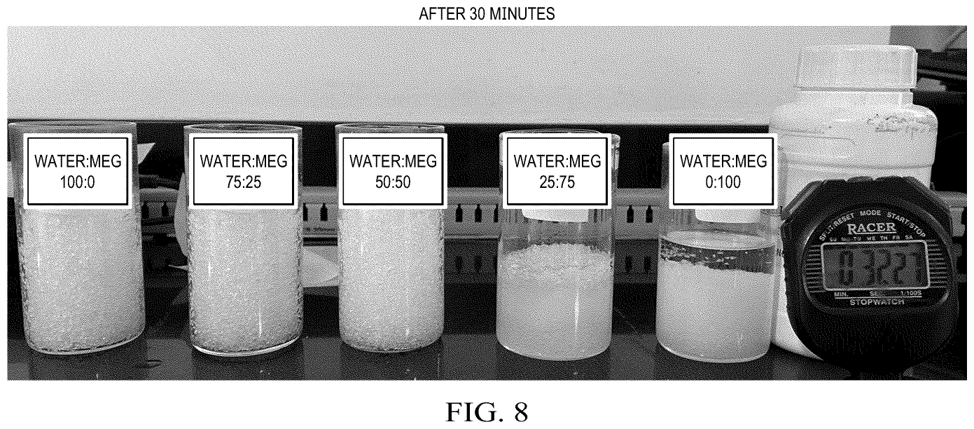

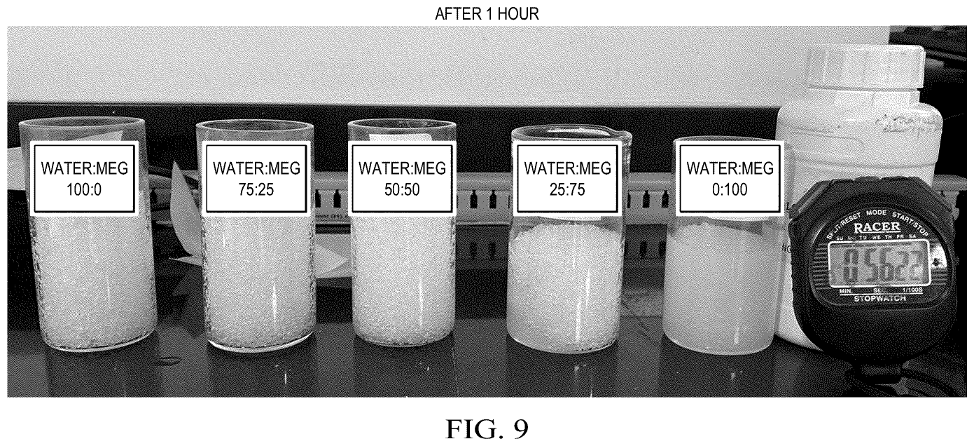

Five different experimental samples were prepared having the following ratios of water to monoethylene glycol: 100:0, 75:25, 50:50, 25:75, 0:100. To these samples, 10 grams of the drying agent were added per 50 milliliters of solution. Photographs were taken before the addition of the drying agent and also at regular time intervals after addition of the drying agent at approximately 45 seconds, 5 minutes, 12 minutes, 30 minutes, and 1 hour. These photographs are provided as FIGS. 4-9. As illustrated by the photographs, the drying agent hydrates when contacting the water.

Provided are drying pills for treating a pipeline in accordance with the disclosure and the illustrated FIGS. An example drying pill comprises a non-aqueous base fluid, and a drying agent. The total volume of the drying pill is 500 bbl or less.

Additionally or alternatively, the drying pill may include one or more of the following features individually or in combination. The base fluid may comprise a non-aqueous fluid selected from the group consisting of methanol, monoethylene glycol, triethylene glycol, isopropyl alcohol, and any combination thereof. The concentration of the base fluid in the drying pill may be in a range of about 50% (w/v) to about 99% (w/v). The drying agent may be selected from the group consisting of crosslinkable polymers, non-water soluble desiccants, swellable clays, and any combination thereof. The drying agent may be a crystalline crosslinkable polymer. The drying agent may be a crosslinkable biopolymer. The drying agent may be a crosslinkable polymer selected from the group consisting of a sodium acrylate-based polymer, crosslinked polyacrylamide, crosslinked polyacrylate, crosslinked hydrolyzed polyacrylonitrile, salts of carboxyalkyl starch, salts of carboxymethyl starch, salts of carboxyalkyl cellulose, salts of carboxymethyl cellulose, salts of any crosslinked carboxyalkyl polysaccharide, crosslinked copolymers of acrylamide and acrylate monomers, starch grafted with acrylonitrile and acrylate monomers, crosslinked polymers of two or more of allylsulfonate, 2-acrylamido-2-methyl-1-propanesulfonic acid, 3-allyloxy-2-hydroxy-1-propane-sulfonic acid, acrylamide, and acrylic acid monomers; amylose, amylopectin, chitosans, hemicelluloses, lignins, celluloses, chitins, alginates, dextrans, pullulanes, polyhydroxyalkanoates, fibrins, cyclodextrins, polylactic acids, activated alumina, molecular sieves, silica gel, zeolites, smectite clays, and any combination thereof. The concentration of the drying agent in the treatment fluid may be in a range of about 1% wt. % to about 60% wt. %.

Provided are methods for treating a pipeline with a drying pill in accordance with the disclosure and the illustrated FIGS. An example method comprises preparing a drying pill comprising a non-aqueous base fluid and a drying agent, wherein the total volume of the drying pill is 500 bbl or less. The method further includes introducing the drying pill into the pipeline and removing the drying pill from the pipeline. The drying agent is hydrated when removed from the pipeline.

Additionally or alternatively, the method may include one or more of the following features individually or in combination. Introducing the drying pill into the pipeline may comprise pumping the drying pill through the pipeline while the drying pill is turbulently flowing through the pipeline. The method may not comprise the use of air dryers, air compressors, or vacuums. The method may not comprise the use of nitrogen air spreads. Preparing the drying pill may comprise mixing the base fluid and the drying agent as the base fluid and the drying agent are introduced into the pipeline. The base fluid may comprise a non-aqueous fluid selected from the group consisting of methanol, monoethylene glycol, triethylene glycol, isopropyl alcohol, and any combination thereof. The concentration of the base fluid in the drying pill may be in a range of about 50% (w/v) to about 99% (w/v). The drying agent may be selected from the group consisting of crosslinkable polymers, non-water soluble desiccants, swellable clays, and any combination thereof. The drying agent may be a crystalline crosslinkable polymer. The drying agent may be a crosslinkable biopolymer. The drying agent may be a crosslinkable polymer selected from the group consisting of a sodium acrylate-based polymer, crosslinked polyacrylamide, crosslinked polyacrylate, crosslinked hydrolyzed polyacrylonitrile, salts of carboxyalkyl starch, salts of carboxymethyl starch, salts of carboxyalkyl cellulose, salts of carboxymethyl cellulose, salts of any crosslinked carboxyalkyl polysaccharide, crosslinked copolymers of acrylamide and acrylate monomers, starch grafted with acrylonitrile and acrylate monomers, crosslinked polymers of two or more of allylsulfonate, 2-acrylamido-2-methyl-1-propanesulfonic acid, 3-allyloxy-2-hydroxy-1-propane-sulfonic acid, acrylamide, and acrylic acid monomers; amylose, amylopectin, chitosans, hemicelluloses, lignins, celluloses, chitins, alginates, dextrans, pullulanes, polyhydroxyalkanoates, fibrins, cyclodextrins, polylactic acids, activated alumina, molecular sieves, silica gel, zeolites, smectite clays, and any combination thereof. The concentration of the drying agent in the treatment fluid may be in a range of about 1% wt. % to about 60% wt. %.

Provided are systems for treating a pipeline with a drying pill in accordance with the disclosure and the illustrated FIGS. An example system comprises a drying pill comprising a non-aqueous base fluid and a drying agent, wherein the total volume of the drying pill is 500 bbl or less. The system further comprises mixing equipment configured to mix the base fluid and the drying agent, and pumping equipment configured to pump the drying pill in the pipeline. The system also comprises a pipeline.

Additionally or alternatively, the system may include one or more of the following features individually or in combination. The pumping equipment may be configured to pump the drying pill in the pipeline under turbulent flow. The mixing equipment may comprise a jet mixer configured to mix the base fluid and the drying agent as the base fluid and the drying agent are introduced into the pipeline. The system may not comprise an air dryer, an air compressor, or a vacuum. The base fluid may comprise a non-aqueous fluid selected from the group consisting of methanol, monoethylene glycol, triethylene glycol, isopropyl alcohol, and any combination thereof. The concentration of the base fluid in the drying pill may be in a range of about 50% (w/v) to about 99% (w/v). The drying agent may be selected from the group consisting of crosslinkable polymers, non-water soluble desiccants, swellable clays, and any combination thereof. The drying agent may be a crystalline crosslinkable polymer. The drying agent may be a crosslinkable biopolymer. The drying agent may be a crosslinkable polymer selected from the group consisting of a sodium acrylate-based polymer, crosslinked polyacrylamide, crosslinked polyacrylate, crosslinked hydrolyzed polyacrylonitrile, salts of carboxyalkyl starch, salts of carboxymethyl starch, salts of carboxyalkyl cellulose, salts of carboxymethyl cellulose, salts of any crosslinked carboxyalkyl polysaccharide, crosslinked copolymers of acrylamide and acrylate monomers, starch grafted with acrylonitrile and acrylate monomers, crosslinked polymers of two or more of allylsulfonate, 2-acrylamido-2-methyl-1-propanesulfonic acid, 3-allyloxy-2-hydroxy-1-propane-sulfonic acid, acrylamide, and acrylic acid monomers; amylose, amylopectin, chitosans, hemicelluloses, lignins, celluloses, chitins, alginates, dextrans, pullulanes, polyhydroxyalkanoates, fibrins, cyclodextrins, polylactic acids, activated alumina, molecular sieves, silica gel, zeolites, smectite clays, and any combination thereof. The concentration of the drying agent in the treatment fluid may be in a range of about 1% wt. % to about 60% wt. %.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of or “consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A drying pill for treating a pipeline, the drying pill comprising:
a non-aqueous base fluid, and
a drying agent; wherein the total volume of the drying pill is 500 bbl or less.

2. The drying pill of claim 1, wherein the base fluid comprises a non-aqueous fluid selected from the group consisting of methanol, monoethylene glycol, triethylene glycol, isopropyl alcohol, and any combination thereof.

3. The drying pill of claim 1, wherein the concentration of the base fluid in the drying pill is in a range of about 50% (w/v) to about 99% (w/v).

4. The drying pill of claim 1, wherein the drying agent is selected from the group consisting of crosslinkable polymers, non-water soluble desiccants, swellable clays, and any combination thereof.

5. The drying pill of claim 4, wherein the drying agent is a crystalline crosslinkable polymer.

6. The drying pill of claim 4, wherein the drying agent is a crosslinkable biopolymer.

7. The drying pill of claim 4, wherein the drying agent is a crosslinkable polymer selected from the group consisting of a sodium acrylate-based polymer, crosslinked polyacrylamide, crosslinked polyacrylate, crosslinked hydrolyzed polyacrylonitrile, salts of carboxyalkyl starch, salts of carboxymethyl starch, salts of carboxyalkyl cellulose, salts of carboxymethyl cellulose, salts of any crosslinked carboxyalkyl polysaccharide, crosslinked copolymers of acrylamide and acrylate monomers, starch grafted with acrylonitrile and acrylate monomers, crosslinked polymers of two or more of allylsulfonate, 2-acrylamido-2-methyl-1-propanesulfonic acid, 3-allyloxy-2-hydroxy-1-propane-sulfonic acid, acrylamide, and acrylic acid monomers; amylose, amylopectin, chitosans, hemicelluloses, lignins, celluloses, chitins, alginates, dextrans, pullulanes, polyhydroxyalkanoates, fibrins, cyclodextrins, polylactic acids, activated alumina, molecular sieves, silica gel, zeolites, smectite clays, and any combination thereof.

8. The drying pill of claim 1, wherein the concentration of the drying agent in the treatment fluid is in a range of about 1% wt. % to about 60% wt. %.

9. A method for treating a pipeline using a drying pill, the method comprises:
preparing a drying pill comprising a non-aqueous base fluid and a drying agent, wherein the total volume of the drying pill is 500 bbl or less;
introducing the drying pill into the pipeline; and
removing the drying pill from the pipeline; wherein the drying agent is hydrated when removed from the pipeline.

10. The method of claim 9, wherein the introducing the drying pill into the pipeline comprises pumping the drying pill through the pipeline while the drying pill is turbulently flowing through the pipeline.

11. The method of claim 9, wherein the method does not comprise the use of air dryers, air compressors, or vacuums.

12. The method of claim 9, wherein the method does not comprise the use of nitrogen air spreads.

13. The method of claim 9, wherein preparing the drying pill comprises mixing the base fluid and the drying agent as the base fluid and the drying agent are introduced into the pipeline.

14. The method of claim 9, wherein the base fluid comprises a non-aqueous fluid selected from the group consisting of methanol, monoethylene glycol, triethylene glycol, isopropyl alcohol, and any combination thereof.

15. The method of claim 9, wherein the drying agent is selected from the group consisting of crosslinkable polymers, non-water soluble desiccants, swellable clays, and any combination thereof.

16. The method of claim 9, wherein the concentration of the drying agent in the treatment fluid is in a range of about 1% wt. % to about 60% wt. %.

17. A system for treating a pipeline using a drying pill, the system comprises:
a drying pill comprising a non-aqueous base fluid and a drying agent, wherein the total volume of the drying pill is 500 bbl or less;
mixing equipment configured to mix the base fluid and the drying agent;
pumping equipment configured to pump the drying pill in the pipeline; and
a pipeline.

18. The system of claim 17, wherein the pumping equipment is configured to pump the drying pill in the pipeline under turbulent flow.

19. The system of claim 17, wherein the mixing equipment comprises a jet mixer configured to mix the base fluid and the drying agent as the base fluid and the drying agent are introduced into the pipeline.

20. The system of claim 17, wherein the system does not comprise an air dryer, an air compressor, or a vacuum.
